(19) United States
(12) Patent Application Publication
(10) Pub. No.: US 2015/0220993 A1
(43) Pub. Date: Aug. 6, 2015

(54) System, Method and Apparatuses for Qualifying Mobile Devices and Providing Information Thereto

(71) Applicant: Robert Bente, West Sayville, NY (US)

(72) Inventor: Robert Bente, West Sayville, NY (US)

(21) Appl. No.: 14/515,443

(22) Filed: Oct. 15, 2014

Related U.S. Application Data
(60) Provisional application No. 61/891,195, filed on Oct. 15, 2013.

(51) Int. Cl. G06Q 30/02; H04L 29/08

(52) U.S. Cl. CPC G06Q 30/0267; G06Q 30/0269; G06Q 30/0261; H04L 67/26

(57) ABSTRACT

Disclosed is a method of qualifying mobile devices and providing information thereto including: receiving a probe request; ascertaining mobile device identity data embedded in the probe request and defining a prospective device identity data; determining whether the prospective device identity data are unqualified; and if not, providing the prospective device identity data to a push server. Apparatuses and systems for performing the method are disclosed as well.

### REFERENCE TO EARLIER APPLICATION

This application incorporates by reference and, under 35 U.S.C. §119(e), claims priority to U.S. Provisional Patent Application Ser. No. 61/891,195 filed on Oct. 15, 2013.

### STATEMENT REGARDING FEDERALLY SPONSORED RESEARCH OR DEVELOPMENT

This invention is not the subject of federally sponsored research or development.

### RESERVATION OF COPYRIGHTS

Portions of the disclosure of this document contain material that is subject to copyright protection. The copyright owner has no objection to any reproduction of the document or disclosure as it appears in official records, but reserves all remaining rights under copyright.

### BACKGROUND OF THE INVENTION

Selling often is a matter of timing. Offering a product to a potential consumer when the consumer is interested in the product tends to lead to a sale. Many techniques have evolved for obtaining this ideal situation from mass communication, such as newspaper coupons, intended for as many people as possible with the hope that someone receiving the communication will be interested, to more researched and thoughtful approaches that consider individuals' preferences and tendencies. But, in addition to being more tailored to the potential consumer's preferences, the timing of presenting an offer to that potential consumer also is critical to making a sale.

The advent of the information age and the world wide web or global internet and growing popular adoption thereof has increased the quantity, diversity of information that is readily accessible from the home, office or essentially anywhere, as well as the ability to provide it to people. In addition to simply establishing a web site and posting information and then waiting passively for potential consumers to find them, many merchants actively search for and engage potential consumers. Initially, this involved transmitting unsolicited facsimiles, emails and text messages. However, as with newspaper coupons, these outreaches, if not met with annoyance, were mostly ineffective having encountered the potential consumer at work or checking messages for other purposes and nowhere near where a sale could be consummated.

More recently, merchants are employing various methods for providing information to potential customers through their mobile cellular communication devices, and more particularly “smart phones” that supplement conventional telephony with software applications that can access the internet for browsing and other activities. Some merchants detect the mobile devices that are brought into their shops and then deliver a “push notification” to the devices. Push notifications may contain special promotions, invitations, electronic coupons or special announcements allowing a marketer, retailer or other establishment to move beyond text and email campaigns and reach users quickly. While quick and potentially more targeted for potential customers who may be proximate to the shop, pushing notifications to any device that ever came or remains near, like a courier's mobile device, remains highly likely to be ineffective to the bulk of the recipients of the notification.

A “push notification” or “server push” refers to an internet-based communication transmitted from a server to a device having a unique address, such as a media access control (MAC) address, a mobile equipment identifier (MEID), an internet protocol (IP) address and the like. Push notifications may be transmitted via non-cellular networks that mobile device proprietors employ among their devices, for example the Google server for messages routed among Android brand devices. Push notifications may employ the Global System for Mobile (GSM) communications network, which uses GPRS, a packet oriented mobile data service on 2G and 3G cellular communications, for transmitting data packets.

A push notification essentially is a link to a “page” stored on a server that is connected to the internet. Providing information via the internet typically relies on technologies that facilitate navigation among “pages” or files stored in servers that are connected to the internet and which users are not required to understand. Exemplary technologies, including the hypertext transfer protocol (HTTP) and extensible markup language (XML), are foundation technologies for the internet that have been fairly universally adopted and implemented in web browsers and servers.

Web browsers, including those on smart phones, essentially translate for users the HTTP and XML code into displays of high-quality text and graphical information in a scrollable paginated format. Typical web pages are related or linked to other pages via embedded hypertext links. Thus, selecting a hypertext link causes a hypertext jump to the selected web page referenced. More specifically, the selection of a hypertext link prompts a browser installed in a computer that is connected to the internet to electronically couple to a website whose address is specified by the hypertext link.

In addition to accessing the internet via cellular communications, mobile devices typically are equipped with short-range communications capability, such as Wi-Fi or Bluetooth, for connecting with wireless local area networks (WLAN) that are connected to the internet and that are becoming increasingly common in public and commercial buildings. WLAN communications typically include a wireless access point (WAP) or node with which the mobile device must establish communications before being able to access the WLAN.

Before a mobile device can communicate via a WAP, it must be in the appropriate connection state. The three connection states are: 1/ not authenticated or associated; 2/ authenticated, but not associated; and 3/ authenticated and associated. A mobile device must be in the first state before communication will be allowed across a WAP.

To effect communication, the mobile device and WAP will exchange a series of management frames in order to assume an authenticated and then an associated state. First, the mobile device transmits probe requests to discover a WLAN or WAP within its proximity. The probe request includes a unique probe request ID (“communications ID” hereinafter) and the mobile device's MAC address along with its communication capabilities.

All WAPs that receive the probe request will confirm whether the mobile device is compatible. If a WAP is compatible, it will transmit a probe response that includes the WAP's identifier and sometimes the network's service set identifier (SSID), supported data rates, encryption types if required, and other capabilities of the WAP.

Ordinarily, at least for initial communications, the mobile device user must manually select the network desired for communication. So, for example, if multiple WAPs are within a communication zone of the device, that is, capable of establishing WLAN communication with the device, then the device would display a list of WAPs from which the user could select for establishing communications.

Eager to capitalize on the ubiquity of internet-connected mobile devices and engage their users, merchants, service providers and many others (collectively “proprietors herein) desire actively providing the users with information pertaining to the proprietor's business, ideally repeatedly. To this end, some proprietors commission applications that may be installed on mobile devices. The applications often are configured to establish a dialogue between user and proprietor, or at least allow the proprietor to provide the user with information, such as a coupon. The application may be programmed to poll the proprietor or designee for the information, typically via communication over the internet.

While providing a potential customer's mobile device with an application and regular information or coupons may increase the likelihood of a sale, such still may not reach the potential customer when the customer is ready or poised for purchasing what is being pushed. For example, a customer shopping in the bedding department of a large department store that receives a push notification with a coupon from the proprietor for fishing tackle elsewhere on the premises may not be in the frame of mind or poised for purchasing fishing tackle.

What are needed and not taught or suggested in the prior art are a system, method and apparatuses for qualifying mobile devices and providing information thereto that provides the information to a receptive recipient who is poised to act on the information in a way that the provider desires.

### SUMMARY OF THE INVENTION

The invention overcomes the disadvantages noted above by providing a system, method and apparatuses for qualifying mobile devices and providing information thereto that provides the information to a receptive recipient who is poised to act on the information in a way that the provider desires.

To that end, an embodiment of a method of qualifying mobile devices and providing information thereto configured according to principles of the invention includes: receiving a probe request; ascertaining mobile device identity data embedded in the probe request and defining a prospective device identity data; determining whether the prospective device identity data are unqualified; and if not, providing the prospective device identity data to a push server.

An embodiment of an apparatus for qualifying mobile devices and providing information thereto configured according to principles of the invention includes: a node having a node processor that has access to a node instruction memory containing node instructions for controlling the node processor. The node processor and the node instructions are configured for: receiving a probe request; ascertaining device identity data embedded in the probe request and defining prospective device identity data; determining whether the prospective device identity data are unqualified; and if not, providing the prospective device identity data to a push server.

An embodiment of another apparatus for qualifying mobile devices and providing information thereto configured according to principles of the invention includes: a server having a server processor that has access to: a server instruction memory that contains server instructions for controlling said server processor; a qualified device memory configured to store qualified device identity data in association with data pertaining to category identification; and an information memory configured to store information in association with an information identification and a node identification, defined as an information node identification. The server processor and server instructions are configured for: receiving a node identification, defining a received node identification, and prospective device identity data; ascertaining whether the received node identification corresponds with an information node identification; and if so, defining the information associated with the information node identification as qualified information; and initiating a push notification respecting the qualified information to a device corresponding to the target device identity.

An embodiment of systems for qualifying mobile devices and providing information thereto configured according to principles of the invention include: the node described above; the server described above; a device having installed therein a program configured to be responsive to the server; and combinations thereof.

The invention provides improved elements and arrangements thereof, for the purposes described, which are inexpensive, dependable and effective in accomplishing intended purposes of the invention.

Other features and advantages of the invention will become apparent from the following description of the preferred embodiments, which refers to the accompanying drawings.

### BRIEF DESCRIPTION OF THE DRAWINGS

The invention is described in detail below with reference to the following figures, throughout which similar reference characters denote corresponding features consistently, wherein:

FIG. 1 is a schematic representation of an embodiment of a method of qualifying mobile devices and providing information thereto configured according to principles of the invention;

FIG. 2 is a schematic representation of an embodiment of a system for qualifying mobile devices and providing information thereto configured according to principles of the invention;

FIGS. 3a-d, 4a-h and 5a-c are graphical representations of images shown on a device in accordance with the method of FIG. 1;

FIGS. 6-8 are graphical representations of displays for implementing the method of FIG. 1; and

FIGS. 9a-d and 10a-b are graphical representations of images shown on a device in accordance with the method of FIG. 1.

### DETAILED DESCRIPTION OF THE PREFERRED EMBODIMENTS

This disclosure is not limited in application to the details of construction and the arrangement of components set forth or illustrated in the drawings herein. The disclosure is capable of other embodiments and of being practiced or of being carried out in various ways. Phraseology and terminology used herein is for description and should not be regarded as limiting. Uses of “including,” “comprising” or “having” and variations thereof herein are meant to encompass the items listed thereafter and equivalents thereof as well as additional items. Unless limited otherwise, “connected,” “coupled” and “mounted,” and variations thereof herein are used broadly and encompass direct and indirect connections, couplings, and mountings. “Connected” and “coupled” and variations thereof are not restricted to physical or mechanical or electrical connections or couplings. Furthermore, and as described in subsequent paragraphs, the specific mechanical or electrical configurations described or illustrated are intended to exemplify embodiments of the disclosure. However, alternative mechanical or electrical configurations are possible, which are considered to be within the teachings of the disclosure. Furthermore, unless otherwise indicated, “or” is to be considered inclusive.

The invention includes a system, method and apparatuses for qualifying mobile devices and providing information thereto.

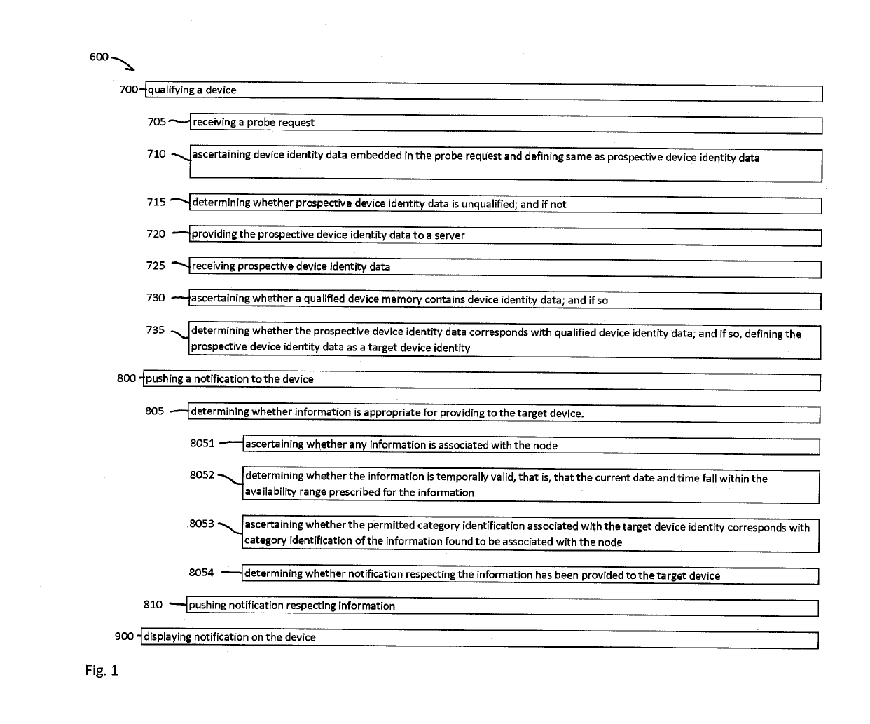

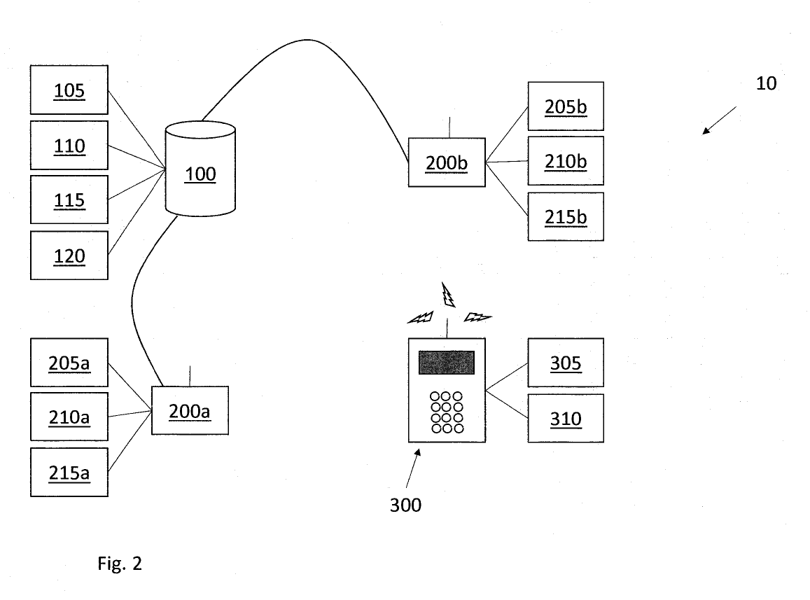

Referring to FIG. 1, a method 600 of qualifying mobile devices and providing information thereto configured according to principles of the invention includes method 700 of qualifying a device for receiving information; and if the device is qualified, method 800 of pushing a notification to the device; and after a device receives a notification, method 900 of displaying the notification on the device. Referring also to FIG. 2, method 700 is partly performed by one or more server(s) 100 and partly by one or more node(s) 200. Method 800 is performed by server 100. Method 900 is performed by a mobile device 300.

Referring to FIG. 2, a system 10 configured according to principles of the invention employs a server 100 and at least one wireless access point (WAP) or node 200, server 100 and node(s) 200 being capable of establishing communication with the internet. A mobile device 300, via an application 1100 installed thereon or at least accessible thereto, provides server 100 with an identification of device 300 along with criteria respecting information that device 300 authorizes receiving. Thereafter, when device 300 is proximate to one of node(s) 200, the proximate node 200 responds to a probe request of device 300 and ascertains whether device 300 is disqualified from receiving information. If not, then node 200 communicates its identification and that of device 300 to server 100. Server 100 evaluates the identifications of the node 200 and device 300, determines what information is available that pertains to that node 200 and whether device 300 authorizes receiving that information. If so, then server 100 originates a push message respecting the information for device 300. Application 1100 responds to the push message and causes device 300 to generate a display that pertains to the information.

Method 600 relies on mobile device 300 installing or at least having access to (collectively “installing” herein) a set of instructions, commonly referred to as a program or application 1100, that a processor 305 of device 300 can execute. For example, the proprietor of an establishment that the user of device 300 is patronizing may encourage the user to download application 1100 by visiting a well-know web-based repository of applications, like the iTunes and Google Play stores and the like, or provide a uniform resource locator (URL) that the user may enter into the browser utility of device 300, or provide a QR, bar or other code representing same that device 300 may be able to scan. Device 300 then reveals on display 315 an image (not shown) that includes a link for installing application 1100 on device 300. Details for locating and installing mobile applications like application 1100 are well known and discussed no further herein.

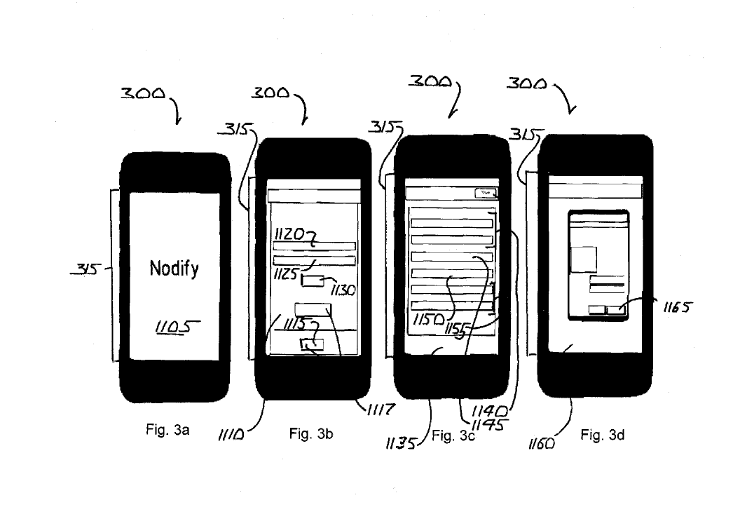

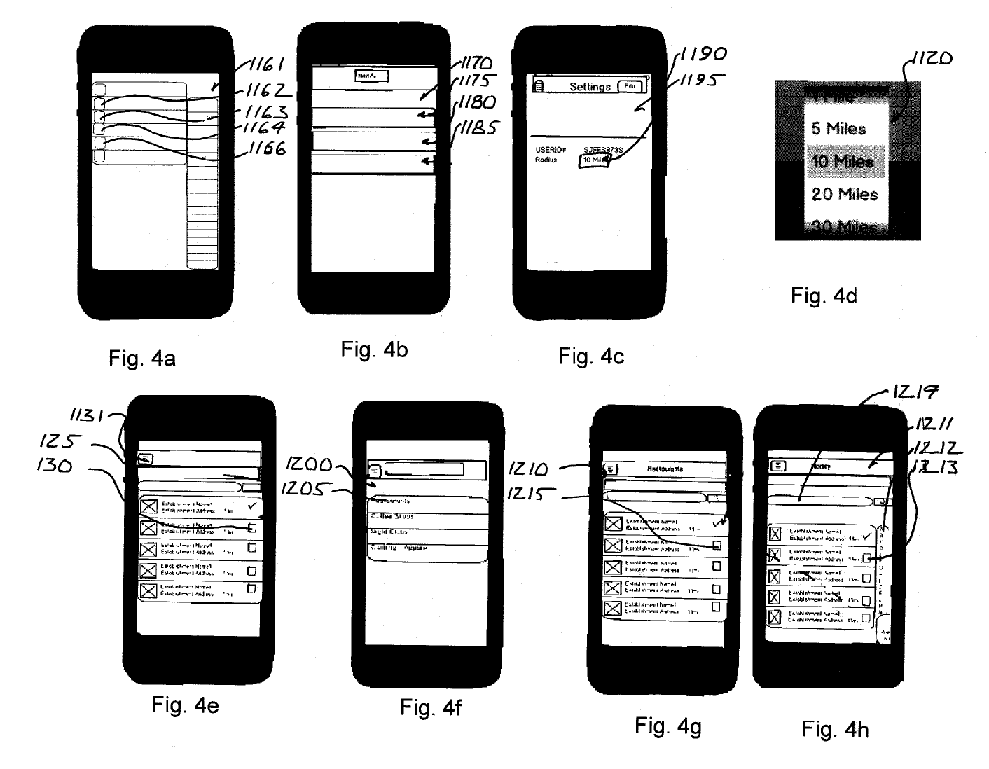

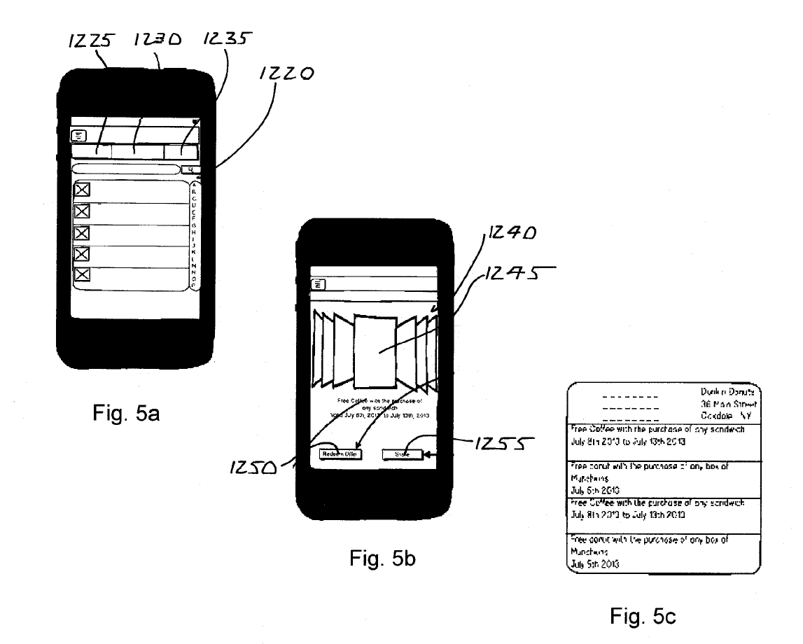

Referring also to FIG. 3a, when application 1100 is installed, it instructs processor 305 to generate a splash screen 1105 to indicate installation is occurring, complete or that application 1100 is running.

Application 1100 then instructs processor 305 to generate a series of images for registering the user and establishing secure access credentials for accessing an account profile associated with the device. Referring to FIG. 3b, application 1100 instructs processor 305 to generate a display 1110 that includes a control 1115 that the user may select for registering and creating a new profile. Alternatively, user may select the control 1117 for registering by associating information associated with internet-accessible data or an internet-based program, such as Facebook®. If the user already had registered, display 1110 also provides text boxes 1120 and 1125 respectively for entering the user's name, which could be the user's email address, and a password, collectively referred to as “credentials,” and then a control 1130 for submitting the credentials and accessing the user's existing profile.

Referring to FIGS. 3b and 3c, selecting control 1115 causes application 1100 to instruct processor 305 to generate an image 1135 with which the user may register by entering personal information, including name 1140, telephone number 1145, email address 1150 and a password 1155. During registration, application 1100 instructs processor 305 to ascertain an identification of device 300. The identification may be one or more of: a MAC address, Bluetooth identification data, MEID and the like.

Referring to FIGS. 3b and 3d, selecting control 1117 causes application 1100 to instruct processor 305 to generate an image 1160 with which a user may enter credentials associated with the internet-accessible data or an internet-based program and then select a control 1165 to permit association of the credentials therewith with application 1100.

Referring to FIG. 4b, once the user's credentials are authenticated, application 1100 instructs processor 305 to generate an image 1170 for entering or modifying criteria respecting permitted push notifications. Image 1170 includes controls 1175, 1180 and 1185 for selecting criteria respectively pertaining to a range, an information type and a name.

Referring also to FIGS. 4c and 4d, selecting control 1175 causes application 1100 to instruct processor 305 to generate an image 1190 that includes a drop-down menu or other type of control 1195 that permits selecting a radius from a list of radii for defining a circle about a permitted geographic region. Selecting control 1195 causes application 1100 to instruct processor 305 to generate an image 1120 in place of control 1195 that shows the radius selections.

The radius originates from generally where device 300 is located. If device 300 moves a predetermined distance, then the location of device 300 may be recalculated. Once entered, processor 305 submits the current location and radius information to server 100 to obtain information respecting the proprietor's stores having an address that falls within the permitted geographic region.

When processor 305 receives the information respecting the proprietor's stores in the permitted geographic region, referring to FIG. 4e, application 1100 instructs processor 305 to generate an image 1125 that lists and shows information pertaining to each store within the selected radius and associates with each a check box 1130 or comparable control that the user may select or deselect. Selecting check box 1130 is interpreted as authorizing or “opting in” to receiving information respecting the associated store.

Referring to FIG. 4b and FIG. 4f, selecting control 1180 causes application 1100 to instruct processor 305 to generate an image 1200 including any number of controls 1205 for selecting categories of information for which push notifications are permitted. Control 1205 may, for example, relate to types of establishments about which information is welcomed or consented to receive. Other non-limiting examples may relate to types of goods, like clothing, food or sporting goods.

Referring also to FIG. 4g, selecting control 1205 causes application 1100 to instruct processor 305 to generate an image 1210 that displays a list of more refined categories associated with whatever category is selected via control 1205. In the example shown on image 1200 of FIG. 4f, image 1210 shows specific establishments that qualify for the “restaurant” category. Image 1210 also a check box 1215 or comparable control that the user may select or deselect. Selecting check box 1215 is interpreted as authorizing or “opting in” to receiving information respecting the associated category. If, for example, the category selected from image 1200 of FIG. 4f were “clothing,” then the more refined categories might include men's coats, mens shoes, womens blazers, etc.

Referring to FIG. 4b and FIG. 4h, selecting control 1185 causes application 1100 to instruct processor 305 to generate image 1211 for selecting a store by its name. Image 1211 includes a control 1212 that permits a user to quickly navigate to the section in the list containing stores having a name beginning with a selected letter of the alphabet. Image 1212 provides a search box 2014 for entering text for searching for stores by name. Image 1212 also provides with each store listed a checkbox 1213 or comparable control that the user may select or deselect. Selecting check box 1213 is interpreted as authorizing or “opting in” to receiving information respecting the associated store.

Referring to FIGS. 4e and 4a, after initial registration, displays associated with application 1100, as sown in FIG. 4e, include a control 1131 that causes application 1100 to instruct processor 305 to generate an image 1161 as shown in FIG. 4a. Image 1161 includes controls 1162, 1163, 1164 and 1166, for selecting viewing respectively of a “wallet,” available offers, the user's profile and settings for application 1100.

Referring also to FIG. 5a, selecting control 1162 causes application 1100 to instruct processor 305 to generate an image 1220 that shows information collections stored on or in association with device 300, the volume or files associated with the information being collectively referred to as a “wallet.” Image 1220 includes controls 1225, 1230 and 1235 for filtering or ordering the collection display according to respectively proximity, category or name.

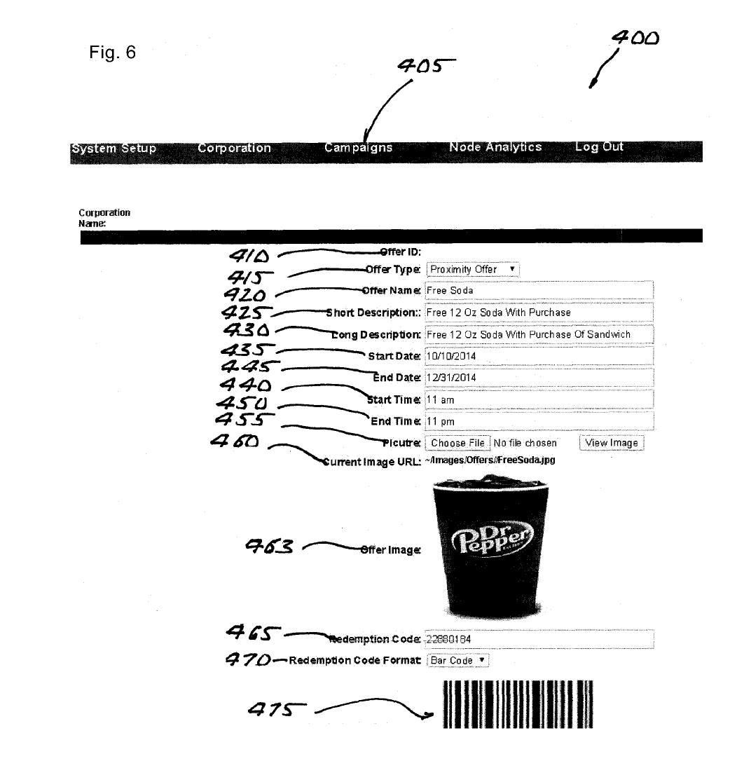

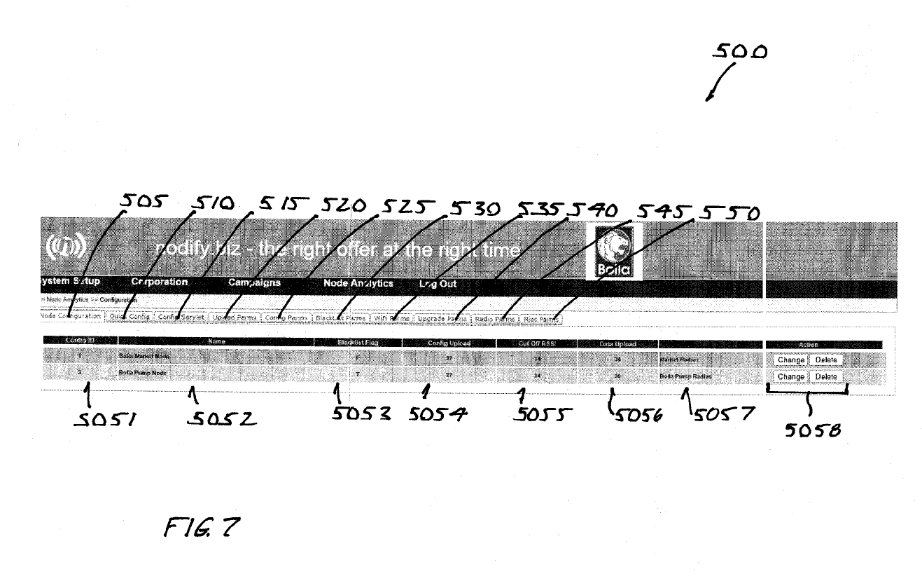

Referring also to FIG. 5b, selecting one of the information collections on image 1220 causes application 1100 to instruct processor 305 to generate an image 1240 and show a virtual “carousel” of information entries 1245 associated with the selected collection. FIG. 5c shows exemplary text and graphics that may be displayed on each information entry 1245. Each information entry 1245 corresponds to an entry or offer that a proprietor creates, as described below with respect to display 400 on FIG. 6 as described below. Image 1240 also includes controls 1250 and 1255 respectively for redeeming or sharing the information.

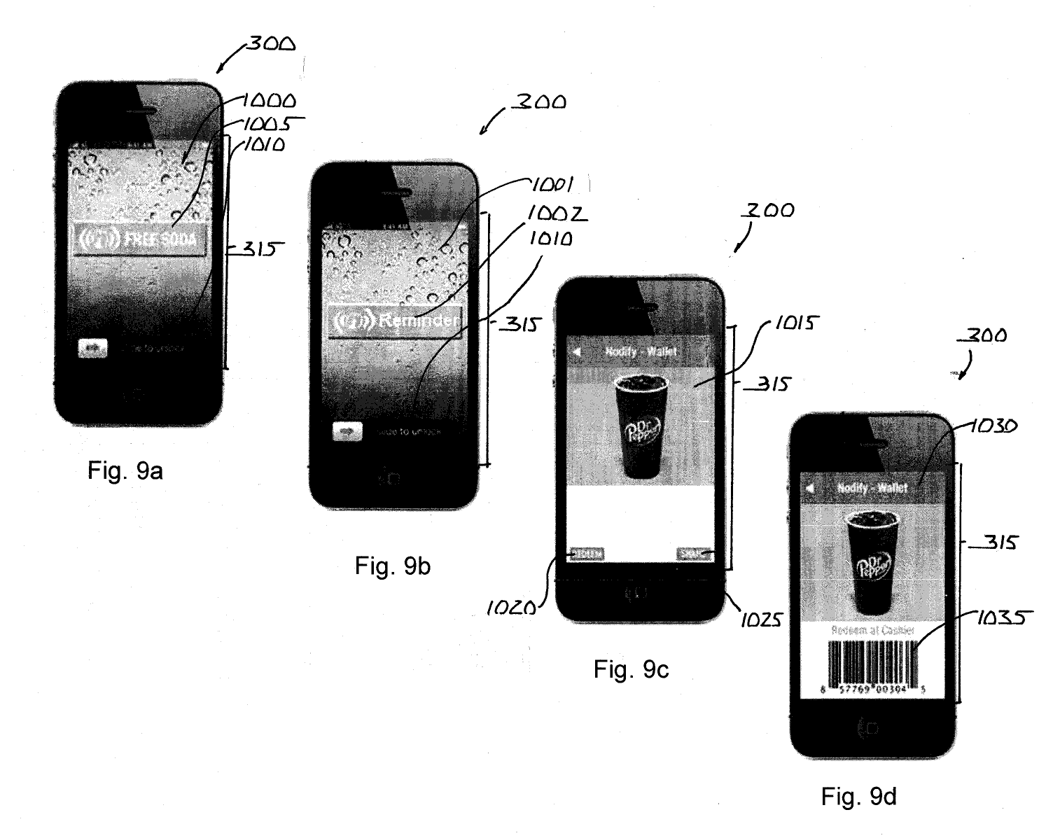

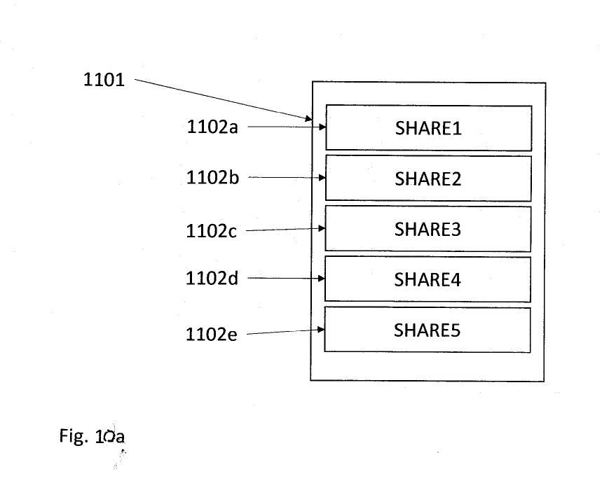

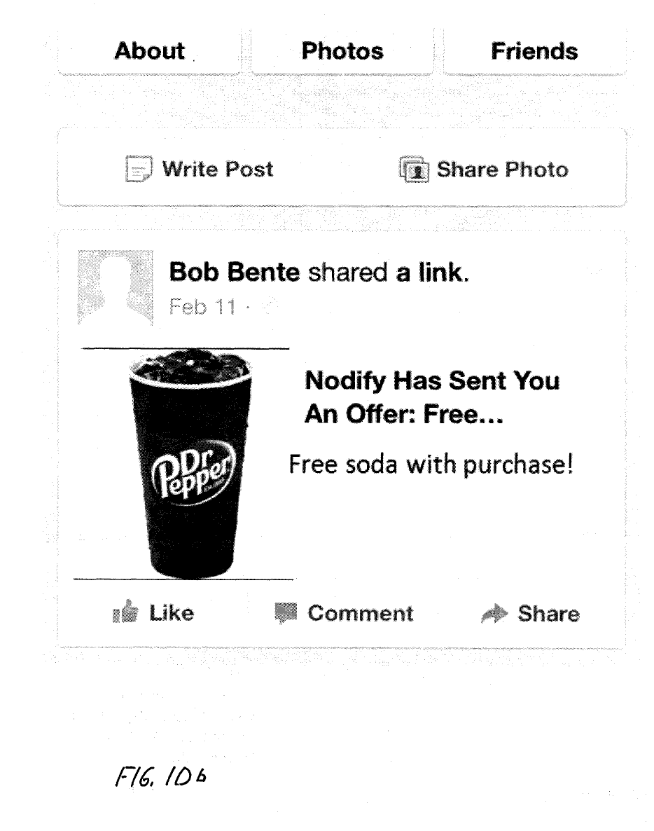

Referring also to FIG. 9d, selecting control 1250 causes application 1100 to instruct processor 305 to generate an image comparable to image 1015 shown on and described below with respect FIG. 9d.

Selecting control 1163 causes application 1100 to instruct processor 305 to generate an image comparable to image 1220 only for available rather than previously accepted information. Processing associated with control 1163 also are comparable to those associated with control 1162 and discussed no further.

Selecting control 1164 causes application 1100 to instruct processor 305 to generate image 1170 as shown and discussed with respect to FIG. 4.

Method 700 is purposed at ascertaining and then notifying server 100 about only devices 300 that are likely to be associated with potential customers. Accordingly, method 700 includes a step 705 of receiving a probe request. Preferably, a node 200 operates as a WAP with which a device 300 may establish communication. As explained above, unless in “airplane” mode or otherwise having short-range communications capabilities disabled, mobile devices regularly transmit probe requests to locate local WAPs that are available for establishing communication. Assuming the signal strength of the probe request is sufficient, node 200, via an operably-connected antenna, will receive the probe request for subsequent processing.

Method 700 does not require that device 300 actually establish communication with any of node(s) 200, only that it broadcast probe requests containing a unique device identifier. Further, while it is preferred that push notifications occur through a node 200 that has established communication with device 300, again, node-device association is not required; server 100 can push a notification via other means or channels at its disposal for reaching device 300.

Method 700 also includes step 710 of ascertaining device identity data embedded in the probe request and defining same as prospective device identity data. As is well known in the art, probe requests are data packets that contain much information about the respective transmitting device, including device identifying and critical communication protocol information. Step 710 involves processing the data packet to reveal the device identity.

Method 700 also includes step 715 of determining whether prospective device identity data is unqualified. This involves confirming whether the prospective device identity data corresponds with device identity data that may exist on a blacklist, as explained in greater detail below. If the prospective device identity data does correspond with device identity data on the blacklist, then the prospective device identity data is unqualified and method 700 terminated. Step 715 minimizes communications among server 100 and node(s) 200, thus minimizes the volume of information respecting unlikely customers that server 100 processes and increases the processing of information respecting likely customers, ultimately leading to more timely and effective push notification.

If the prospective device identity data is not unqualified, then method 700 also includes step 720 of providing the prospective device identity data to server 100 for further processing. This occurs because both server 100 and node(s) 200 are connected to and able to communicate via the internet.

As explained in greater detail below, step 720 should include providing to server 100 the identity of the node 200 that qualified, thus is proximate to device 300. The node identification aids in filtering information that could be pushed to only information pertinent to the items or area proximate to the node.

Preferably, method 700 also includes disqualifying devices that are not close enough to node 200. The invention is intended to engage customers when they are most ready to complete a sale, which may be more likely when a customer is near a sale item. While proximity to an item is no guarantee of high sales potential (e.g. customer engaging in telephone conversation might be interested in a sale item one foot away), the contrapositive is more likely, hence more reliable (e.g. bedding department customer is probably not interested in fishing tackle). This nearness disqualification can be based on measuring and comparing the signal strength of the mobile device against a threshold signal strength that node(s) 200 detect(s) as is well known in the art.

Preferably, method 700 also includes disqualifying devices that do not linger by a node 200. For example, a customer passing through the fishing tackle department on the way to the bedding department may, but is not likely to be interested in fishing tackle. As with the nearness disqualification, this persistence disqualification also can be based on measuring and comparing the signal strength of the mobile device against a threshold signal strength that node(s) 200 detect(s) and timing how long the signal strength has met or exceeded a threshold duration or dwell time.

Assuming that step 720 occurs, method 700 is continued on server 100 and is purposed at qualifying a prospective device. If qualified, method 700 proceeds to step 800 of pushing a notification to the device. Accordingly, method 700 includes step 725 of server 100 receiving prospective device identity data from a node 200. Step 725 should be responsive to step 720 above and assume that the transmitting node 200 and server 100 have been paired and configured for internet-based communication.

Method 700 also includes step 730 of ascertaining whether any qualified device data exists in a qualified device identity data. If not, then method 700 and further processing are terminated, freeing up the processor for subsequent processing.

If there is qualified device identity data, then method 700 also includes step 735 of determining whether the prospective device identity data corresponds with any of the qualified device identity data. As with above, if not, then method 700 and further processing are terminated.

If the prospective device identity data does correspond with qualified device identity data, then the prospective device identity data is qualified and defined as a target device identity. Method 800 then begins with a step 805 of determining whether any information is appropriate for or has been authorized for providing to the target device.

Information refers to unique sets of data that a proprietor desires to make accessible to a device, for example text and images pertaining to a campaign, as described in greater detail below in relation to FIG. 6. New information refers to information that has not been provided to a device. Previously-presented information refers to information that has been provided to and remains on a device, but about which a proprietor may want to remind the device user.

Every information entry is associated with a unique information identification. The information identification is intended to be associated with at least one node identification and at least one category or quality identification. The node identification identifies the node for which information may be appropriate. For example, the identification of a node located in the bedding department would be best associated with information pertaining to bedding, like a discount on down comforters. The category identification is explained in greater detail above in relation to FIG. 4.

Step 805 includes step 8051 of ascertaining whether any information is associated with the node identification provided at step 720 above. If so, then method 800 and processing continues to step 8052, otherwise terminate.

Step 8052 involves determining whether the information is temporally valid, that is, that the current date and time fall within the availability range prescribed for the information. If so, then method 800 and processing pass to step 8053, otherwise method 800 and process terminate.

Step 8053 provides for ascertaining whether the permitted category identification associated with the target device identity, the category of information that the device user authorizes receiving, corresponds with category identification of the information found to be associated with the node in step 8051. If so, then method 800 and process passes to step 8054, otherwise method 800 and process terminate.

Step 8054 provides for determining whether any notification respecting the information has been provided to the target device. As is well understood in the database arts, tables may be generated that cross reference mobile device identifications and the information identifications of information for which notifications were initiated. If the information had been provided, then the notification is defined as a reminder notification, otherwise as an original notification, and in either case, method 800 and processing pass to step 810.

Step 810 provides for pushing a notification apprising the user of the information that is available to the user as may be appropriate for the device.

Assuming that step 810 occurs, method 900 is purposed at displaying a corresponding notification on the target device 300.

Referring to FIGS. 1 and 9a, responsive to a push notification consistent with step 810, if the notification is defined as an original notification, then application 1100 causes processor 305 to generate an image 1000 that may be viewed on a display screen 315. Image 1000 presents a message, such as “Free Soda,” or other text and graphics configured to convey an impression of an opportunity or availability of information.

Referring to FIG. 9b, if the notification is defined as a reminder notification, then application 1100 causes processor 305 to generate an image 1001 that may be viewed on a display screen 315. Image 1001 presents a message, such as “Reminder,” or other text and graphics configured to convey an impression of an opportunity or information that remains available.

Via image 1000 or 1001, if the user “swipes” or selects either icon 1005 or 1002, or unlock slide 1010, referring to FIG. 9c, application 1100 causes processor 305 to generate an image 1015. Information displayed in image 1015 corresponds to information entered via display 400 as shown and discussed in relation to FIG. 6. Image 1015 provides a control 1020 for redeeming the offer and a control 1025 for sharing the offer.

Referring to FIG. 9d, selecting control 1020 causes application 1100 to instruct processor 305 to generate an image image 1030 including a scanable code 1035 having a format that may be selected as explained below for redeeming the offer associated with image 1015. The proprietor can process code 1035 by scanning or other known ways.

Once code 1035 is processed or the information of image 1015 otherwise redeemed, then information pertaining to the transaction are provided to server 100 and information pertaining to the offer removed from device 300 and no longer displayed in the “wallet.”

Referring to FIGS. 9c and 10a, selecting control 1025 causes application 1100 to instruct processor 305 to generate an image 1101 that shows controls 1102 for selecting one of various ways that the information may be shared, for example via text message, Instagram, Facebook and other social networking applications. When the user selects one of controls 1102, application 1100 causes processor 305 to launch the appropriate sharing utilities that associated with each control, for example packaging text and graphics for SMS communication. Processor 305 may transmit a message to server 100 that device 300 shared the associated information with another.

Referring to FIG. 10b, the receiver of shared information receives the information shared in accordance with how the associated application ordinarily displays notifications. For example, FIG. 10b shows how the shared information is seen via a Facebook notification. If the shared information is a redeemable coupon as shown, then the receiver would redeem the coupon by patronizing the proprietor's establishment where the receiver would receive the push notification respecting the coupon that the receiver could then redeem as described above.

System 10 for carrying out method 600 includes server 100 that is configured to include or at least be in communication with a processor 105 and a memory 110 for containing instructions for processor 105. Preferably, memory 110 contains server instructions that, when executed, permit a proprietor to store information and assign criteria for when the information may be accessed. Preferably, memory 110 also contains node instructions that, when executed, permit a proprietor to assign parameters to node(s) 200. Preferably, server 100 is configured to include or at least be in communication with a memory 115 that is configured to contain data respecting mobile devices. Preferably, server 100 is configured to include or at least be in communication with a memory 120 that is configured to contain data respecting information that can be provided to mobile devices.

Referring to FIG. 6, the invention provides for enabling a proprietor to navigate via the internet to a web page that generates a display 400. Display 400 provides a menu 405 for developing a marketing campaign. Each campaign is associated with a unique Offer ID 410. Display 400 provides for: selecting an offer type 415; entering an offer name 420; entering a short description 425; entering a long description 430; selecting a start date 435 and start time 440; selecting an end date 445 and end time 450; and uploading and associating an image 460. Offer type 415 may be selected from, for example: a coupon offer for receiving a discounted or free offer; an event invitation for inviting users to, e.g. the grand opening of a new store opening; a loyalty card for reminding users that they have an loyalty card and the application 1100 at their disposal, including pending offers in their “wallet.”

Offer name 420 can assume essentially any textual expression that aids the proprietor in identifying the campaign associated with Offer ID 410. Further distinguishment may be achieved with short description 425, which also can assume essentially any textual expression for briefly describing the nature of the campaign. Even further comprehension may be enhanced with long description 430, which also can assume essentially any textual expression for detailed explanation of the campaign.

Start date 435, start time 440, end date 445 and end time 450 may be entered in any conventional format. These parameters restrict when server may permit access to information associated with the campaign associated with Offer ID 410 to between and including start time 440, end date 445 and end time 450.

Uploading and associating an image 460 is intended to permit an image of any file format to be associated with the campaign associated with Offer ID 410. Preferably, considerate of limited storage and operating capabilities understood for various brands or configurations of mobile devices, the image uploaded is optimized for transmitting, storing and viewing on the target device. For example, the uploaded image may be condensed to present a more basic spectrum of colors so that the file size associated with the image is smaller. This permits more rapid transmission, storage, retrieval and other processing of push notifications so that a user receives and can respond to the notification in a more timely manner. Display 400 displays a thumbnail image 463 of the uploaded image to confirm that the appropriate image has been loaded and for ready reference.

In addition to generating a unique Offer ID 410, instructions 115 also generate a redemption code 465. The redemption code is homologated to the point of sale terminal for ready parsing of other information pertinent to the transaction at hand.

Display 400 provides for selecting a redemption code format 470, which may be selected from text, bar or QR codes, and like identifying indicia. This is the format in which the redemption code will be displayed in a coupon ultimately rendered on a users device, as described below. Display 400 displays a thumbnail image 475 of the redemption code as represented in the format selected to confirm that the appropriate format has been selected.

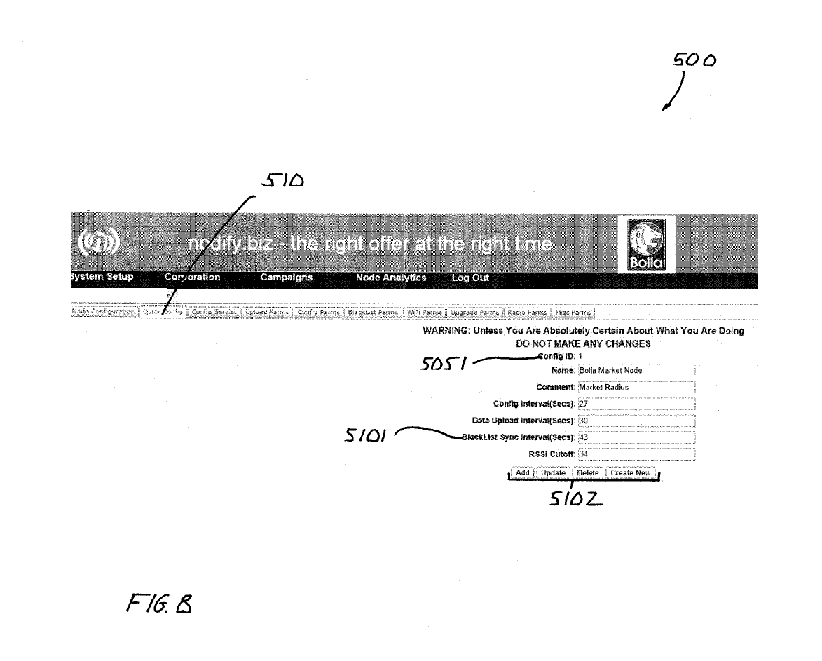

Referring to FIGS. 7 and 8, preferably, node instructions 120 generate a display 500 including, as shown in FIG. 7, a plurality of tabs 505-550 for establishing parameters for operation of node(s) 200 with respect to server 100 and a device 300.

Referring again to FIG. 2, each of node(s) 200 is configured to include or at least be in communication with a processor 205 and a memory 210 for containing instructions for processor 205. Preferably, each node 200 is configured to include or at least be in communication with a memory 215 that is configured to contain data respecting mobile devices.

Referring to FIG. 7, tab 505 is configured for displaying a list of nodes 200, each row on tab 505 including a unique Config. ID 5051 that corresponds to a respective node 200a and node 200b in FIG. 2. Tab shows a name 5052; a black list flag 5053; a configuration upload 5054; a Cut Off RSSI 5055; a data upload 5056; a comment 5057; and controls 5058. Name 5052 may assume essentially any textual expression for helping to identify or distinguish a node 200, particularly with respect to its location on an proprietor's premises.

As explained above, timing for pushing information is key. The invention is intended to provide to a user information respecting what is proximate to a node 200 when the user who has opted into receiving information and proximate to the node 200 for a sufficient duration. Because the user is not expected to remain stationary, once the duration criterium is met, a prompt push is critical. Accordingly, the invention is configured to reduce overhead or minimize communications among server 100 and node(s) 200 to minimize processing and gain precious time getting information to a user in time to attract action on the information. For example, if a customer receives a push notification respecting a discount offered on an item in front of the user, the user, having remained proximate the item for the requisite duration, hence potentially interested in purchasing the item, may be more inclined to respond positively to the pushed discount notification than if the user had already left the store and is turning out of the parking lot.

To reduce server-node communications, the invention provides for pre-filtering devices that represent characteristics of, but are not mobile devices, such as local or neighboring WAPs that are not nodes 200, firewalls of desktop computers with wireless capabilities, routers, and so forth. Accordingly, if node 200 detects the same device within a span of, for example, 40 minutes, then the device is deemed immobile and the identification associated with the device stored in memory 215, commonly referred to as a blacklist. Before communicating the identification of a device to server 100 to ascertain whether to push information to the device, processor 205 must confirm that the identification does not correspond with any identifications on the blacklist. Otherwise, depending on the sampling rate of a node 200, local immobile devices would be detected and reported to server 100 frequently. Especially where a proprietor maintains many nodes 200 in each of many premises, the volume of communication associated with immobile would be quite large and slow processing of push notifications to potential customers who may no longer be near or interested.

Accordingly, black list flag 5053 represents for each device on the blacklist described above, the level of black flag, ranging from those that are permanent and clearly qualify for being on the blacklist through candidates that merit further consideration before being deemed more permanent members.

Cut Off RSSI 5055 corresponds to an area or range within which proprietor desires node 200 to be responsive to a device 300. As described above, a device 300 transmits a probe request, which would have a signal strength, for initiating WLAN communications. Cut Off RSSI 5055 relates to a minimum signal strength that would be required for the node to qualify device 300, as described more below.

Referring also to FIG. 8, Tab 510 provides a quick configuration utility for each node having Config. ID 5051 including in addition to what was described above: a blacklist sync interval 5101 and controls 5102. Blacklist sync interval 5101 refers to the amount of time that should elapse before processor 205 requests from server 100 data maintained in memory 115 pertaining to blacklisted devices for that node 200.

In practice, each node 200 will reboot or shutdown and restart preferably daily. After node 200 reboots, it waits a period of time corresponding to the sync interval before requesting the blacklist data from server 100. This is to avoid situations where a proprietor maintains multiple nodes that, if all simultaneously requested data from server 100, might render server 100 unable to process all requests or inoperable. During the sync interval, node 200 continually samples for probe requests and records the identities of local devices.

Since rebooting is intended to occur at times when the proprietor tends to expect low patronage, for example when the proprietor's store is closed, then the devices node 200 will detect will tend to be permanent or otherwise disqualifiable. Once the proscribed blacklist sync interval elapses, node 200 transmits to server 100 the identities of the devices detected. Thereafter, server 100 compares and retains on the blacklist the identities of those devices that node 200 transmitted and purges the identities that the node had not detected. This assures a proprietor that the permanent devices that are inappropriate for push notifications are maintained on the list, while erring on the side of including those devices that may have been added to the blacklist by mistake (e.g. customer mistakenly left a device behind and retrieved it on the next day).

Ordinarily device users may or must manually select a network desired for communication. So, for example, if multiple WAPs are within a communication zone of the device, that is, capable of establishing WLAN communication with the device, then the device would display a list of WAPs from which the user could select for establishing communications. According to the invention, when the user launches the proprietor's application, the SDK embedded in the application will limit the list to show only WAPs that can support the application by providing it with the MAC address, or WAPs that have permitted IDs. Alternatively, the SDK will automatically select the proprietor's WAP.

Another embodiment of the invention provides for the SDK terminating an existing short-range communication that may have been established with a WAP that is not the proprietor's or otherwise permitted and then establishing communications with the proprietor's WAP as above.

The invention is not limited to the particular embodiments described and depicted herein, rather only to the following claims.

I claim:

1. Node comprising a node processor that has access to a node instruction memory containing node instructions for controlling said node processor;
wherein said node processor and the node instructions are configured for:
receiving a probe request;
ascertaining device identity data embedded in the probe request and defining prospective device identity data;
determining whether the prospective device identity data are unqualified; and if not,
providing the prospective device identity data to a push server.

2. Node of claim 1, wherein the device identity is selected from a media access control address, a Bluetooth address, a mobile equipment identifier and combinations thereof.

3. Node of claim 1, wherein said node processor has access to a disqualified device memory configured to store disqualified device identity data;
wherein said node processor and the node instructions are configured for:
ascertaining whether the disqualified device memory contains disqualified device identity data; and if so,
determining whether the prospective device identity data correspond with any disqualified device identity data in the disqualified device memory.

4. Node of claim 3, wherein the disqualified device identity data correspond to mobile devices that are detected for a duration that is greater than or equal to disqualification duration.

5. Node of claim 4, wherein:
the disqualified device identity data are synchronized with a blacklist memory, defining synchronized disqualified device identity data; and
after the disqualified device memory is purged, until a blacklist sync interval elapses, said processor ascertains and stores in the disqualified device memory mobile device identity data embedded in probe requests, the memory mobile device identity data stored being defined as interim disqualified device identity data.

6. Node of claim 5, wherein the synchronized disqualified device identity data are purged of device identity data not included in the interim disqualified device identity data.

7. Node of claim 1, wherein said node processor and the node instructions are configured for:
determining whether a proximity corresponding to the probe request is less than or equal to a qualifying proximity value; and if so
defining the prospective device identity data as unqualified; and/or
determining whether a duration that a proximity corresponding to probe request has been less than or equal to a qualified range is greater than or equal to a qualifying duration; and if so
defining the prospective device identity data as unqualified.

8. Server comprising a server processor that has access to:
a server instruction memory that contains server instructions for controlling said server processor;
a qualified device memory configured to store qualified device identity data in association with data pertaining to category identification; and
an information memory configured to store information in association with an information identification and a node identification, defined as an information node identification;
wherein said server processor and the server instructions are configured for:
receiving a node identification, defining a received node identification, and prospective device identity data;
ascertaining whether the received node identification corresponds with an information node identification; and if so,
defining the information associated with the information node identification as qualified information; and
initiating a push notification respecting the qualified information to a device corresponding to the target device identity.

9. Server of claim 8, wherein said server processor and server instructions are configured for, prior to the initiating:
receiving a category identification associated with the target device identity, defined as a received category identification;
determining whether the received category identification corresponds with a category identification associated with the qualified information; and if not
defining the qualified information as unqualified information.

10. System for proximity promotion comprising:
said server of claim 8; and
a node comprising a node processor that has access to a node instruction memory containing node instructions for controlling said node processor;
wherein said node processor and the node instructions are configured for:
receiving a probe request;
ascertaining device identity data embedded in the probe request and defining prospective device identity data;
determining whether the prospective device identity data are unqualified; and if not,
providing the prospective device identity data to said server.

11. Method of qualifying a mobile device comprising:
receiving a probe request;
ascertaining mobile device identity data embedded in the probe request and defining a prospective device identity data;
determining whether the prospective device identity data are unqualified; and if not,
providing the prospective device identity data to a push server.

12. Method of claim 11, wherein said determining occurs within a local area network that excludes the push server.

13. Method of claim 11, wherein the mobile device identity data are selected from a media access control address, a Bluetooth address, a mobile equipment identifier and combinations thereof.

14. Method of claim 11, said determining comprising:
ascertaining whether a disqualified device memory contains disqualified device identity data; and if so,
determining whether the prospective device identity data correspond with any disqualified device identity data in the disqualified device memory.

15. Method of claim 14, wherein the disqualified device identity data correspond to mobile devices that are detected for a duration that is greater than or equal to disqualification duration.

16. Method of claim 14, wherein the disqualified device identity data are synchronized with a blacklist memory, defining synchronized disqualified device identity data;
further comprising:
purging the disqualified device memory; and until a blacklist sync interval elapses
ascertaining and storing in the disqualified device memory mobile device identity data embedded in the probe request, the mobile device identity data stored being defined as interim disqualified device identity data.

17. Method of claim 16, further comprising purging the synchronized disqualified device identity data of data not included in the interim disqualified device identity data.

18. Method of claim 11, further comprising:
determining whether a proximity corresponding to the probe request is less than or equal to a qualifying proximity value; and if so
defining the prospective device identity data as unqualified; and/or
determining whether a duration that a proximity corresponding to probe request has been less than or equal to a qualified range is greater than or equal to a qualifying duration; and if so
defining the prospective device identity data as unqualified.

19. Method of claim 11, further comprising:
receiving the prospective device identity data;
ascertaining whether a qualified device memory contains device identity data; and if so
determining whether the prospective device identity data correspond with qualified device identity data in the qualified device memory; and if so
defining the prospective device identity data as a target device identity.

20. Method of claim 19, wherein the mobile device identity data is stored in the qualified device memory during installation or execution of an application accessible to the mobile device.

21. Method of claim 22, further comprising:
receiving the push notification; and
transmitting the push notification to the device.

22. Method of providing information comprising:
method of claim 19;
receiving node identification data corresponding to a node performing said receiving, defined received node identification data;
ascertaining whether information is associated with a node identification that corresponds with the received node identification data; and if so,
defining the information as qualified information; and
initiating a push notification respecting the qualified information to a device corresponding to the target device identity.

23. Method of claim 22, further comprising prior to said initiating:
receiving a category identification associated with the target device identity, defined as a received category identification;
determining whether the received category identification corresponds with a category identification associated with the qualified information; and if not
defining the qualified information as unqualified information.

24. Method of claim 22, further comprising prior to said initiating:
ascertaining whether a push notification respecting the qualified information had been initiated for a device corresponding to the target device identity; and if so
defining the push notification as a reminder push notification; and if not
defining the push notification as a new push notification.

25. Method of claim 22, further comprising generating a display having a control on the mobile device responsive to the push notification.

26. Method of claim 25, further comprising, responsive to selecting the control, storing data respecting the information on the device.
